(19) United States
(12) Patent Application Publication
(10) Pub. No.: US 2026/0342759 A1
(43) Pub. Date: Oct. 29, 2026

(54) METHOD AND DEVICE FOR MANAGING GROUP CHAT MESSAGE, AND ELECTRONIC DEVICE

(71) Applicant: NETEASE (HANGZHOU) NETWORK CO., LTD., Hangzhou, Zhejiang (CN)

(72) Inventors: Xin LI, Hangzhou, Zhejiang (CN); Leqi ZHU, Wenzhou, Zhejiang (CN)

(73) Assignee: NETEASE (HANGZHOU) NETWORK CO., LTD., Hangzhou, Zhejiang (CN)

(21) Appl. No.: 19/110,927

(22) PCT Filed: May 12, 2023
(86) PCT No.: PCT/CN2023/093947

§ 371 Date: Mar. 12, 2025

(30) Foreign Application Priority Data
Sep. 27, 2022 (CN) 202211184335.4

(51) Int. Cl. H04L 51/216

(52) U.S. Cl. CPC H04L 51/216

(57) ABSTRACT

The present disclosure relates to a method for managing a group chat message, including: in response to a creation operation of a target topic, displaying topic content with a topic tag of the target topic in a group chat content display area, wherein a graphical user interface is provided by a terminal device, the graphical user interface includes the group chat content display area, and the group chat content display area is configured to display content sent by a group member in a target group; and in response to a viewing operation for the topic tag, displaying a topic management page of the target topic, wherein the topic management page is configured to display the topic content under the target topic.

### CROSS-REFERENCE TO RELATED APPLICATION

The present disclosure is a U.S. National Stage Application of International Application No. PCT/CN2023/093947, filed on May 12, 2023, which is based upon and claims the priority to the Chinese Patent Application NO. 202211184335.4, entitled “METHOD AND DEVICE FOR MANAGING GROUP CHAT MESSAGE, AND ELECTRONIC DEVICE”, filed on Sep. 27, 2022, the entire contents of which are incorporated herein by reference for all purposes.

### TECHNICAL FIELD

The present disclosure relates to the field of instant communication technologies, and in particular to a method and device for managing a group chat message, and an electronic device.

### BACKGROUND

In a group chat, different group members may need to discuss different topics at the same time, and even the same group member may need to participate in discussions on different topics. A chat window displays messages for different topics according to sending times. If group members participating in the target topic want to search for messages on the target topic, they need to check historical messages one by one.

### SUMMARY

According to an aspect of the present disclosure, there is provided a method for managing a group chat message, including: in response to a creation operation of a target topic, displaying topic content with a topic tag of the target topic in the a group chat content display area, wherein a graphical user interface is provided by a terminal device, the graphical user interface comprises the group chat content display area, and the group chat content display area is configured to display content sent by a group member in a target group; and in response to a viewing operation for the topic tag, displaying a topic management page of the target topic, wherein the topic management page is configured to display the topic content under the target topic.

According to an aspect of the present disclosure, there is further provided an electronic device, including a processor and a memory, wherein computer-executable instructions that are executable by the processor are stored in the memory, and the processor executes the computer-executable instructions to implement the method for managing the group chat message of any one of the first aspects.

According to an aspect of the present disclosure, there is further provided a non-transitory computer-readable storage medium having computer-executable instructions stored thereon, which, when invoked and executed by a processor, cause the processor to implement the method for managing the group chat message of any one of the first aspects. topic management page

### BRIEF DESCRIPTION OF THE DRAWINGS

FIG. 1 is a schematic diagram of a group chat interface according to an embodiment of the present disclosure;

FIG. 2 is a flowchart of a method for managing a group chat message according to an embodiment of the present disclosure;

FIG. 3 is a schematic diagram of a topic management page according to an embodiment of the present disclosure;

FIG. 4 is a schematic diagram of another topic management page according to an embodiment of the present disclosure;

FIG. 5 is a schematic diagram of another topic management page according to an embodiment of the present disclosure;

FIG. 6 is a schematic diagram of another topic management page according to an embodiment of the present disclosure;

FIG. 7 is a schematic diagram of prompt information for a designated group member according to an embodiment of the present disclosure;

FIG. 8 is a schematic diagram of another topic management page according to an embodiment of the present disclosure;

FIG. 9 is a schematic diagram of another prompt information for a designated group member according to an embodiment of the present disclosure;

FIG. 10 is a schematic diagram of a topic creation method according to an embodiment of the present disclosure;

FIG. 11 is a schematic diagram of another topic creation method according to an embodiment of the present disclosure;

FIG. 12 is a schematic diagram of a topic viewing method according to an embodiment of the present disclosure;

FIG. 13 is a schematic diagram of another topic viewing method according to an embodiment of the present disclosure;

FIG. 14 is a schematic structural diagram of a device for managing a group chat message according to an embodiment of the present disclosure; and

FIG. 15 is a schematic structural diagram of an electronic device according to an embodiment of the present disclosure.

### DETAILED DESCRIPTION

In order to make objectives, technical solutions and advantages of embodiments of the present disclosure clearer, the technical solutions of the present disclosure will be clearly and completely described below in conjunction with the accompanying drawings. Obviously, the described embodiments are part of the embodiments of the present disclosure, rather than all of the embodiments. Based on the embodiments in the present disclosure, all other embodiments obtained by those skilled in the art without creative work are within the protection scope of the present disclosure.

In a group chat, different group members may need to discuss different topics at the same time, and even the same group member may need to participate in discussions on different topics. However, a chat window displays messages for different topics according to sending times, resulting in discussion information for a target topic being pushed down by the newly sent messages. If group members participating in the target topic want to search for messages on the target topic, they need to check historical messages one by one, which is time-consuming and laborious.

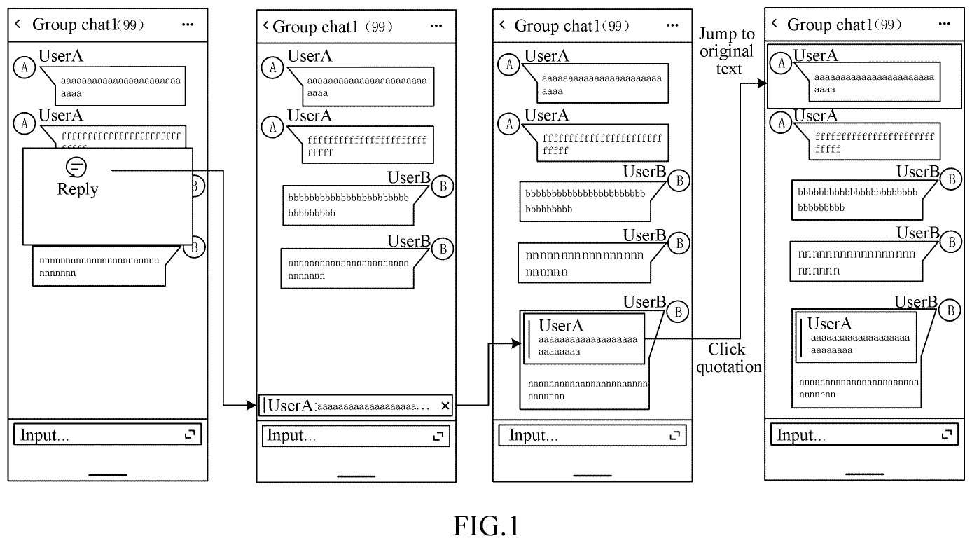

In the related arts, a separate group chat can be recreated to discuss the target topic in the separate group chat. Specifically, a user needs to exit a group chat session, click Create Group, select a group member of the group, and then create a new group, enter a message in the group and send it. However, the way of creating the new separate group chat will cause group members to have more similar groups, and the management efficiency is low. Alternatively, as shown in FIG. 1, in order to clarify the issue under discussion, a quote reply function can be used. For example, a message panel of a target message “aaa . . . ” of user A is launched by right clicking, a reply control displayed in the panel is selected, and the reduced target message “aaa . . . ” will be displayed above an input box of a group chat interface. The user can enter a reply message “nnn . . . ” for the target message in the input box and send it, then the reply message sent by the user will carry the target message of user A (i.e., the quotation “aaa . . . ” in FIG. 1), which is used to indicate that the message “nnn . . . ” sent by user B is the reply message to the target message “nnn . . . ” of user A. In this way, the user in the group chat can click on the target message to jump the group chat interface to a display position of the quotation sent by user A.

However, for multi-layer quotes, group members need to jump step by step to view the discussion messages of the topic. If the group chat includes discussion messages of multiple topics, there is still the problem of chaotic display of messages. The group member cannot centrally view the content of a certain topic and discuss it. For a topic, the related content cannot be centrally browsed, and a topic manager cannot add messages or remove irrelevant messages, resulting in low communication efficiency and low group management efficiency, and poor user communication experience. Embodiments of the present disclosure provide a method and device for managing a group chat message, and an electronic device, which can be applied to a terminal device such as a mobile phone, a tablet, and a computer, and can be particularly applied to a terminal device with a chat function.

To facilitate understanding of embodiments of the present disclosure, the method for managing the group chat message disclosed in the embodiments of the present disclosure is first introduced in detail. A graphical user interface is provided by a terminal device, and the graphical user interface includes a group chat content display area, and the group chat content display area is configured to display content sent by a member of a target group. The group chat content display area further includes a group chat name, the number of group chat members, group member avatars, nicknames and content sending times of the target group, as well as a message input box and a discussion control, etc.

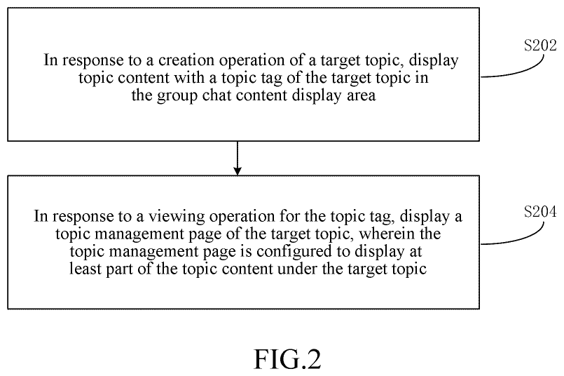

As shown in FIG. 2, the method for managing the group chat message includes steps S202 and S204.

In the step S202, in response to a creation operation of a target topic, topic content with a topic tag of the target topic is displayed in the group chat content display area.

The target topic is typically a topic created by a topic creator, and the target topic may be content input by a user or content automatically generated according to a target message. The group chat content display area refers to an interface of a group chat session. The topic tag of the target topic typically includes part of the content in the target topic, or may also include all the content of the target topic. In actual implementation, the topic tag of the target topic usually displays the target topic in a specified format, such as highlighting or displaying in a specified color. In addition, the topic tag also includes a specified identifier, such as a chat bubble pattern, etc. The topic content with the topic tag of the target topic may be specifically displayed in the group chat content display area in the format of “topic tag topic content”.

In actual implementation, the target topic may be directly created based on a target group chat message currently displayed in the group chat content display area, and the target group chat message is controlled to be displayed as the topic content with the topic tag of the target topic. The topic tag is typically automatically generated based on the target group chat message, and the topic content is the target group chat message. Alternatively, the target topic may also be directly created based on a target topic creation control in the group chat content display area, and the topic content is entered, thereby generating the topic content with the topic tag of the target topic, and the topic content with the topic tag of the target topic is controlled to be displayed in the group chat content display area.

For example, there are icon buttons with different identifiers below the message input box of the graphical user interface. If the user wants to create a topic for discussion, he/she can first click an icon button with a discussion identifier below the input box, and enter a topic name of the target topic to be created for discussion in the input box, such as design method exchange meeting, brand planning exchange meeting, or weekly statistics, etc. The user enters the topic name of the target topic and ends it with the space bar and then enters the topic content, so as to create the topic tag of the target topic and the topic content, clicks a sending button to send the topic content with the topic tag of the target topic and display it in the group chat content display area.

In addition, messages that have been sent may also be viewed in the group chat content display area. When a discussion topic for one of the target messages needs to be created, the creator can right-click the target message that needs to be converted into the topic discussion to display an operation panel, which displays the icon button with the discussion identifier. The icon button is clicked to create the topic tag of the target topic. After “Send” is clicked, the target topic is created and the topic content with the topic tag is displayed in the group chat content display area.

In the step S204, in response to a viewing operation for the topic tag, a topic management page of the target topic is displayed, and the topic management page is configured to display at least part of the topic content under the target topic.

The viewing operation for the topic tag may be to click on the topic tag and display the topic management page in the graphical user interface, realizing the function of viewing the topic content under the target topic. The topic management page not only displays the topic content under the target topic, but also typically includes the topic name of the target topic, a configuration control for the target topic and other information. Alternatively, a content input box is also included, in which the user can enter the topic content and send it to participate in the discussion of the target topic.

In response to the viewing operation for the topic tag, a preview page is typically displayed first, in which the topic content under the target topic can be browsed. In addition, the topic content may also be entered and sent in the preview page to participate in the discussion of the target topic. In addition, a triggering operation to display the topic management page can also be triggered by a topic viewing control. Specifically, the topic viewing control provided by the graphical user interface is clicked to display different topics created in the current group chat, and a topic you want to view is clicked to display a topic page of the topic. In addition, the triggering operation for the topic management page can also be triggered by prompt information displayed in the group chat content display area. Specifically, the prompt information displayed in the group chat content display area is clicked to display the topic management page of the topic related to the prompt information. The group member in the target group can centrally view at least part of the topic content under the target topic through the topic management page. The topic content is messages sent by some group members in the target group. In addition, the topic content can be sent and received in the topic management page to carry out the discussion, without being affected by other topics.

In addition, the topic management page usually also includes a control for managing the target topic, such as managing the group member of the target group, the time for discussing the target topic, and the topic content about the target topic, etc. Specifically, after launching the topic management page, the group member of the target group (such as the topic creator of the target topic) can manage the target topic by clicking the relevant configuration control. The topic creator can manage different content through different controls, such as setting the target group member to remind the target group member to participate in the discussion of the target topic; adding the discussion time of the target topic, and reminding the target group member of the specific discussion time period and the remaining discussion time of the target topic; adding or deleting the topic content about the target topic in the topic management page; creating a discussion group for the target topic, etc.

In the method for managing the group chat message, in response to the creation operation of the target topic, the topic content with the topic tag of the target topic is displayed in the group chat content display area; and in response to the viewing operation for the target topic, the topic management page of the target topic is displayed, and the topic management page is configured to display at least part of the topic content under the target topic. In this method, the group member of the target group can create different topics for discussion in the group chat interface. For different topics, not only can you distinguish discussion messages of different topics by topic tags, but you can also centrally view discussion messages about the topic through the topic management page. The interruption of irrelevant messages is avoided, and branch discussions of different topics can be completed without creating a new group. In addition, the topic content can be managed on the topic management page, which improves the communication efficiency and group management efficiency for different topics in the group chat, and also improves the user's communication experience.

In addition, the method further includes: in response to a sliding operation for the topic management page, controlling the topic content in the topic management page to scroll. That is, in the topic management page, the user can control the scrolling of the topic content by the touch sliding operation for the page, which facilitates the user to view the historical topic content.

The topic management page also includes a configuration control, and the method further includes: in response to a configuration operation for the configuration control, obtaining configuration information for the target topic; and configuring the target topic according to the configuration information.

The configuration control is used to configure the configuration information of the target topic. The configuration control is displayed on the topic management page, and the topic creator can launch, by clicking the configuration control, a configuration page to configure the configuration information of the target topic. The configuration information typically includes group member information that reminds to participate in the discussion of the target topic, the discussion time of the target topic, the discussion message under the target topic, etc. For example, a member to be reminded is configured for the target topic, a discussion duration is configured for the target topic, the new topic content is added to the target topic, the topic content currently displayed on the management page is deleted for the target topic, the discussion group is created for the target topic, etc.

In actual implementation, based on the topic management page, the topic creator can click on the configuration control to launch the configuration interface for configuration operations, thereby obtaining the configuration information of the target topic. There are multiple configuration controls, which can be used to set a designated group member, add the discussion time, adjust the discussion message about the target topic in the topic management page, create the discussion group, etc. When the configuration operation is completed, prompt information related to the configuration information is typically generated and sent to a terminal device corresponding to the designated group member participating in the discussion of the target topic, and if no designated group member is set, the prompt information will be sent to terminal devices corresponding to all group members in the target group. In this method, the target topic can be configured through the configuration control, which further improves the user's management efficiency of the discussion topic.

The configuration control includes a reminder configuration control, which is used to configure a reminder message for the target topic. An implementation of in response to the configuration operation for the configuration control, obtaining the configuration information for the target topic, and configuring the target topic according to the configuration information is: in response to the configuration operation for the reminder configuration control, obtaining the configuration information for the target topic; and displaying, according to the configuration information, the reminder message for the target topic in the group chat content display area.

The reminder message can be a reminder message for the discussion duration of the target topic, or a reminder message for the group member of the target topic, which is mainly used to remind the group member to participate in the discussion of the target topic, or to remind the group member of the discussion duration or the remaining discussion duration of the target topic. In actual implementation, the user can click on the reminder configuration control to display a configuration window, select the group member required to be reminded in the configuration window, or select the discussion time period of the target topic, etc., to obtain the configuration information for the target topic. The configuration information can be relevant information of the group member or time information. When the configuration is completed, the reminder message will be generated, and the reminder message for the target topic will be finally displayed in the group chat content display area.

The reminder message can be text information, icon information, a text label, etc. For example, it can be a reminder bubble, in which the reminder text for the target topic is recorded, which is used to remind the group member of the relevant information about the target topic, such as reminding the group member to participate in the discussion of the target topic, the discussion time of the target topic, the discussion message update of the target topic, or the conversion from discussion to the group chat.

In this method, the configuration information of the target topic is configured through the reminder configuration control on the topic management page, and then the reminder message is displayed in the group chat content display area, so that the group member can learn the configuration of the target topic in time, improving the communication efficiency and topic management efficiency.

The reminder configuration control includes a first reminder configuration control, and an implementation of in response to the configuration operation for the reminder configuration control, obtaining the configuration information for the target topic; and displaying, according to the configuration information, the reminder message for the target topic in the group chat content display area includes:
in response to a configuration operation for the first reminder configuration control, determining a group member to be reminded for the target topic, and the configuration information includes the group member to be reminded; and sending the reminder message for the target topic to the group member to be reminded to cause the group chat content display area displayed on a terminal device of the group member to be reminded to display the reminder message.

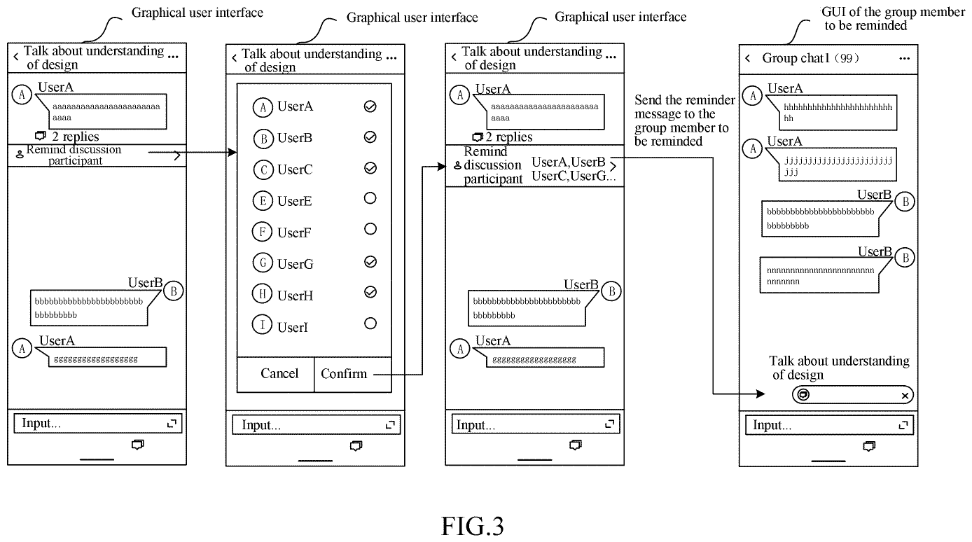

The first reminder configuration control can usually be used to configure the group member who participates in the discussion of the target topic. The terminal device of the group member to be reminded is a terminal device controlled by a user corresponding to the group member to be reminded. In actual implementation, the first reminder configuration control in the topic management page of the target topic can be clicked, and “Remind discussion participant” shown in FIG. 3 corresponds to the first reminder configuration control. Then information of group members in the target group chat and the corresponding selection controls are displayed on the topic management page, such as “User A”, “User B”, “User C”, “User D”, “User E”, “User F”, “User G”, “User H”, “User I” as shown in FIG. 3, where the selection control corresponds to the circle ◯ in FIG. 3, ◯ indicates that the group member is not selected, and ◯ with a √ mark indicates that the group member is selected. A display order of group members is sorted according to the first letter order of nicknames of the group members, or the group members are sorted according to the time of joining the group, or the group member who has participated in the discussion of the target topic is ranked in front (at this time, the selection control corresponding to the user is selected), and separated from the group member who has not yet participated in the discussion of the target topic. The displayed group member information can be the avatar, the nickname, etc. The selection control corresponding to the group member information is selected, as shown in FIG. 3, the selected designated group members are “User A”, “User B”, “User C”, “User G”, and “User H”. Finally, the displayed button with the word “Cancel” or “Confirm” is clicked to cancel or complete the selection operation for the group member to be reminded, and the selected group member is determined as the group member to be reminded of the target topic.

When the group member to be reminded is determined, the reminder message is generated, and the reminder message includes the topic name of the target topic, such as “Talk about understanding of design” as shown in FIG. 3, which is used to remind the group member to be reminded that he/she can participate in the discussion of the topic “Talk about understanding of design”. Then the reminder message is sent to the group member to be reminded, that is, to the terminal device of the group member to be reminded. When the terminal device receives the reminder message, the reminder message is displayed at a designated position in the group chat content display area provided by the terminal device. The reminder message can be displayed at the designated position of the group chat content display area in the display format of a reminder bubble, such as the reminder message shown in FIG. 3, where the discussed target topic is “Talk about understanding of design”, which is displayed near the input box at the bottom of the group chat content display area of the group member to be reminded, including the discussion icon, the topic name of the target topic “Talk about understanding of design” and a close control (corresponding to “×” in FIG. 3). At this time, the group member to be reminded can learn that someone reminds him/her to participate in the discussion of the topic “Talk about understanding of design”.

In this method, the group member to be reminded can be selected through the first reminder configuration control in the topic management page, and the reminder message can be sent to the group member to be reminded, so as to remind the group member to be reminded to participate in the discussion of the target topic, thereby improving the management efficiency, and providing the user with the good communication experience.

In order to further improve the user's communication experience and grasp the timeliness of the discussion, the reminder is given to the group member of the target topic required to be discussed. In addition to the first reminder configuration control, the reminder configuration control also includes a second reminder configuration control, which is used to configure a discussion time period or a discussion duration of the target topic. An implementation of in response to the configuration operation for the reminder configuration control, obtaining the configuration information for the target topic, and displaying, according to the configuration information, the reminder message for the target topic in the group chat content display area is: in response to the configuration operation for the second reminder configuration control, determining a discussion duration for the target topic, and the configuration information includes the discussion duration; and displaying, according to the discussion duration, the reminder message for a remaining discussion duration of the target topic in the group chat content display area.

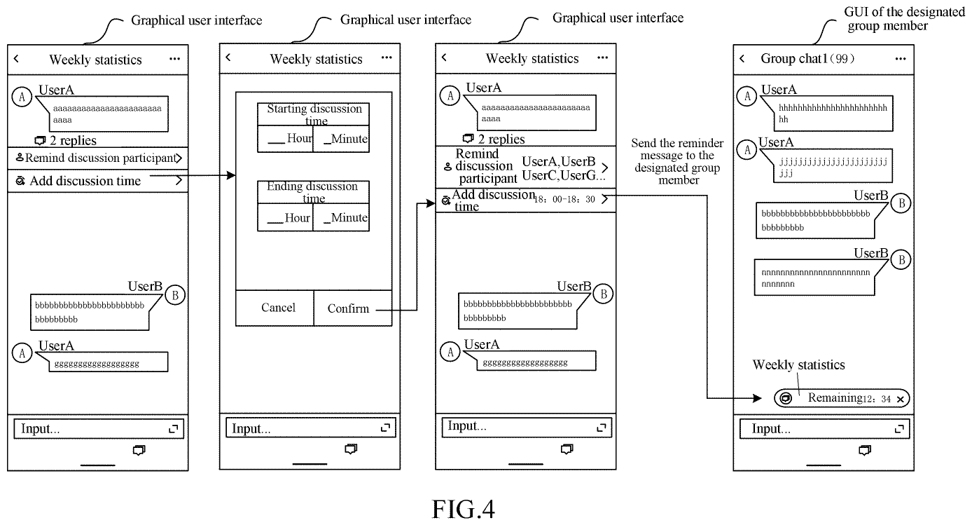

In actual implementation, a second message configuration control in the topic management page of the target topic can be clicked, as shown in FIG. 4, the name of the second message configuration control can be “Add discussion time”. Then a time selection control is displayed on the topic management page, as shown in FIG. 4, the time selection control can be two square boxes with hour and minute selection functions, placed side by side, a hour bar or a minute bar is clicked to slide up and down to select the starting discussion time and the ending discussion time. When the starting discussion time and the ending discussion time are selected, a button with the word “Confirm” is clicked to determine the discussion duration for the target topic, and then the reminder message for the remaining discussion duration of the target topic is generated based on the discussion duration, and the display of the topic management page is also restored, and the selected discussion time is displayed in a display area of the second reminder configuration control. The reminder message is sent to the terminal device of the designated group member, and the reminder message includes the remaining discussion time of the target topic, and can also include the topic name of the target topic. The designated group member can be all group members in the target group, or a pre-configured group member, or a group member who sends the topic content under the target topic.

When the terminal device of the designated group member receives the reminder message, the reminder message for the remaining discussion duration of the target topic is displayed in the group chat content display area of the designated group member, as shown in FIG. 4, the reminder message for the remaining discussion duration of the target topic is displayed near the input box at the bottom of the group chat content display area, and the reminder message for the remaining discussion duration of the target topic includes: the remaining discussion time of the topic. Alternatively, the reminder message for the remaining discussion duration of the target topic can also include: the topic name “Weekly statistics” and the remaining discussion time of the topic. In addition, the discussion icon and the close control (such as the “×” shown in FIG. 4) are also included.

In this method, the discussion duration of the target topic can be selected through the second reminder configuration control in the topic management page, and the designated group member can be reminded to participate in the discussion of the target topic within the discussion time period, thereby standardizing the discussion duration and improving the user's communication experience.

Furthermore, the method further includes: in response to the remaining discussion duration being equal to zero, hiding the reminder message. That is, the designated group member can select the close control to hide the reminder message, or the reminder message can also be automatically hided when the remaining duration is equal to zero. The discussion duration is typically displayed in a countdown manner in the reminder message for the discussion duration of the target topic.

If group members who can participate in the discussion of the target topic are configured when the target topic is created, but one of the group members is forgotten to be configured during the configuration process, the discussion message about the target topic sent by this group member is displayed in the group chat content display area. Alternatively, the group member is configured when the target topic is created, but the group member does not send a message in a second message display area, nor does he/she click on the topic name to reply to the message, but directly sends the discussion message about the target topic in the group chat content display area of the group chat, resulting in missing messages in the discussion messages about the target topic, making it impossible for the group member to browse all the discussion messages about the target topic in a centralized manner.

The configuration control includes a message configuration control, which is used to add a discussion message for the target topic. An implementation of in response to the configuration operation for the configuration control, obtaining the configuration information for the target topic includes: in response to the configuration operation for the message configuration control, displaying the group chat content display area; and in response to a selection operation for the target content in the group chat content display area, using the target content as the configuration information; and
an implementation of configuring the target topic according to the configuration information includes: adding the target content to the topic management page of the target topic.

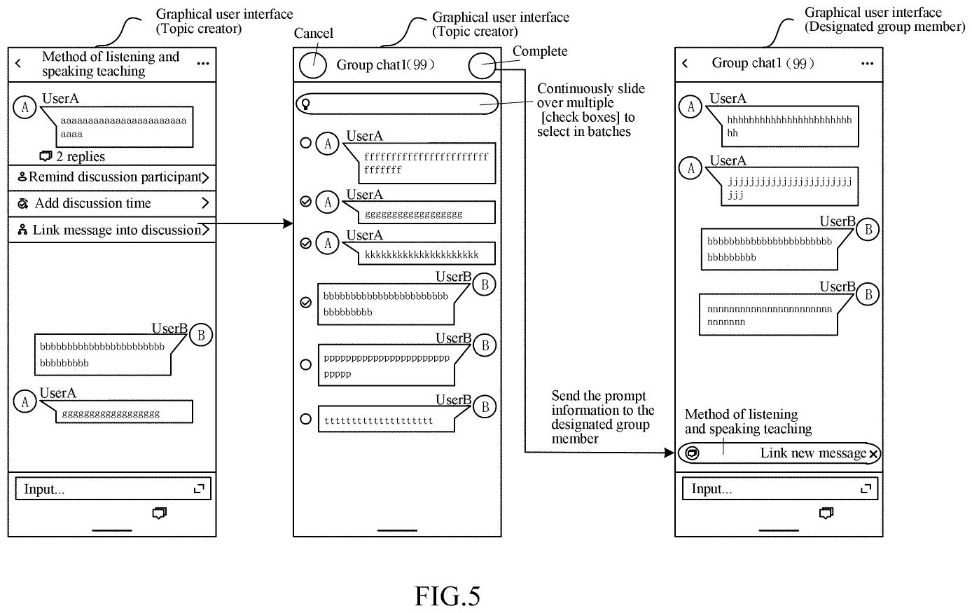

The message configuration control can be a message addition configuration control. In actual implementation, the message configuration control in the topic management page of the target topic can be clicked, as shown in FIG. 5, the name of the message configuration control is “Link message into discussion”. Then the group chat content display area will be displayed in the graphical user interface, which displays all messages sent by all group members of the target group and the corresponding selection controls, as shown in FIG. 5, there will be a selection control in front of each message of “User A” and “User B”, where the selection control corresponds to the circle ◯ in FIG. 5, ◯ indicates that the message is not selected, and ◯ with the √ mark indicates that the message is selected. As shown in FIG. 5, the selected target content is messages “ggg . . . ” and “kkk . . . ” of user A, and a message “bbb . . . ” of user B, and the target content can be used as the configuration information. Then a confirmation control (such as a completion control in FIG. 5) is clicked to link the selected target content to the topic management page of the target topic.

The selection operation for the target content can involve selecting a single message or batch-selecting multiple messages by continuously sliding over multiple blank check boxes. Finally, the displayed button with the word “Cancel” or “Complete” is clicked to cancel or complete the selection operation for the target content.

In addition, in an implementation, when the selection operation for the target content is completed, and the target content is added to the topic management page of the target topic, prompt information that the new message is added is sent to a designated terminal device corresponding to the designated group member, and the prompt information that the new message is added is used to prompt the designated group member that the new topic content has been added to the topic management page of the target topic corresponding to the designated group member.

The designated group member can be all group members of the target group, or a group member who sends the topic content under the target topic, or a pre-configured group member. Specifically, the prompt information that the new message is added can be generated, and the prompt information includes the topic name of the target topic, such as “Method of listening and speaking teaching” as shown in FIG. 5, which is used to prompt the designated group member that the new message has been added to the topic of “Method of listening and speaking teaching”. Then, prompt information for the message linking is sent to the designated terminal device corresponding to the designated group member. When the designated terminal device receives the prompt information, the prompt information is displayed near the input box at the bottom of the group chat content display area of the terminal device of the designated group member, including the discussion icon, the topic name of the target topic “Method of listening and speaking teaching”, “Link new message” used to prompt that the topic content of the target topic has been updated and the close control (corresponding to “×” in FIG. 5). When the designated group member receives the prompt information, the designated group member can know that the new message has been added to the topic of “Method of listening and speaking teaching”.

In this method, through the message configuration control in the topic management page, the target content that is not under the target topic can be selected from the group chat content display area, and added to the topic management page of the target topic, which can organize and improve the discussion messages, aggregate the relevant content of the target topic to facilitate the user to browse. Moreover, the post-linking is a remedial measure for organizing the messages, which improves the management efficiency.

Furthermore, the method further includes: in response to the selection operation for the target content in the group chat content display area, adding the topic tag of the target topic to the target content in the group chat content display area.

That is to say, not only will the target content be added to the topic management page of the target topic, but in order to enable the group member to know in the group chat content display area that the target content is the topic content under the target topic, when the user selects the target content in the group chat content display area, the topic tag of the target topic will be added to the target content in the group chat content display area to indicate that the target content is the topic content under the target topic, thereby further improving the topic management efficiency in the group chat.

If group members who can participate in the discussion of the target topic are configured when the target topic is created, but a group member unrelated to the target topic is configured during the configuration process, the discussion message sent by the group member is displayed on the topic management page of the target topic. Alternatively, a group member accidentally clicks on the topic tag of the target topic in the group chat interface to reply to the message, resulting in some irrelevant messages in the topic content under the target topic, causing the group member to be troubled by the irrelevant messages when browsing the topic content under the target topic.

Based on this, the configuration control includes a message configuration control, which can be called a message deletion configuration control, and used to delete the topic content under the target topic. An implementation of in response to the configuration operation for the configuration control, obtaining the configuration information for the target topic includes: in response to the configuration operation for the message configuration control, controlling the topic content in the topic management page to enter a selectable state; and in response to a selection operation for target topic content in the topic management page, using the target topic content as the configuration information; and
an implementation of configuring the target topic according to the configuration information includes: deleting the target topic content from the topic management page of the target topic.

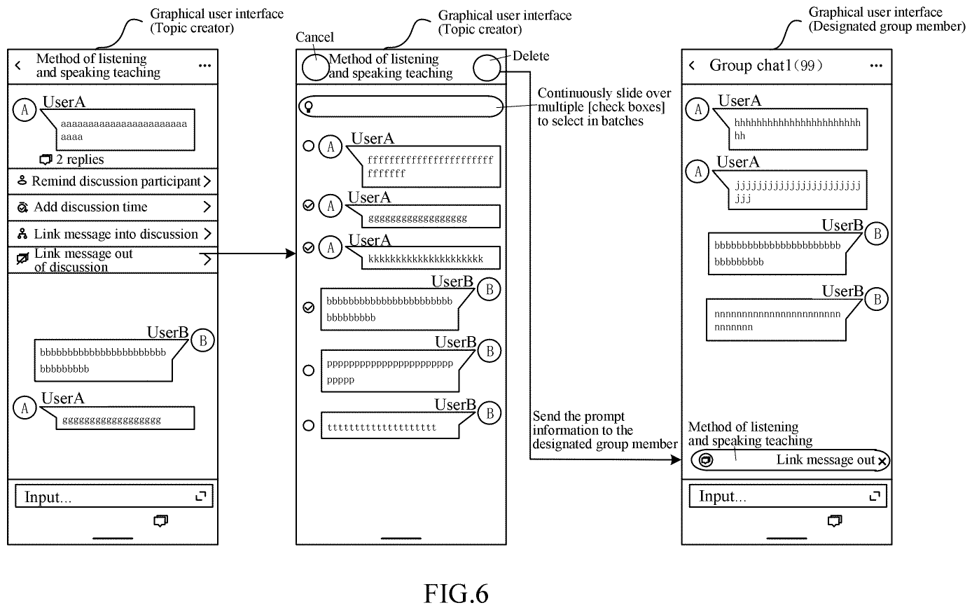

The topic content in the topic management page refers to the topic content under the target topic. In actual implementation, the message configuration control in the management page of the target topic can be clicked, as shown in FIG. 6, the name of the message configuration control can be “Link message out of discussion”. Then the topic management page of the target topic will be displayed in the graphical user interface, which displays the topic content under the target topic and the corresponding selection controls, as shown in FIG. 6, there will be a selection control in front of each message of “User A” and “User B”, where the selection control corresponds to the circle ◯ in FIG. 6, ◯ indicates that the message is not selected, and ◯ with the √ mark indicates that the message is selected. The user can select the single topic content or continuously select the topic content. The selected target topic content can be used as the configuration information. Finally, the displayed button with the word “Cancel” or “Delete” is clicked to cancel the deletion of the selected topic content or delete the selected topic content, that is, the target topic content is deleted from the topic management page of the target topic.

In addition, in an implementation, when the target topic content is deleted from the topic management page of the target topic, prompt information that the message is deleted is sent to the designated group member, and the prompt information that the message is deleted is used to prompt the designated group member that part of the topic content has been deleted from the topic management page of the target topic corresponding to the target topic.

The designated group member can be all group members of the target group, or a group member who sends the topic content under the target topic, or a pre-configured group member. Specifically, the prompt information that the message is deleted may be generated, and the prompt information includes the topic name of the target topic, such as “Method of listening and speaking teaching” as shown in FIG. 6, which is used to prompt the designated group member that some messages under the topic “Method of listening and speaking teaching” have been deleted. Then, the prompt information that the message is deleted is sent to the designated terminal device corresponding to the designated group member. When the designated terminal device receives the prompt information that the message is deleted, the prompt information that the message is deleted is displayed near the input box at the bottom of the group chat content display area of the terminal device of the designated group member, including the discussion icon, the topic name of the target topic “Method of listening and speaking teaching”, the prompt information “Link message out” for prompting that part of the topic content under the target topic has been deleted, and the close control (corresponding to “×” in FIG. 6). When the designated group member receives the prompt information that the message is deleted, he/she can learn that the discussion message has be deleted from the topic “Method of listening and speaking teaching” in which he/she participated in the discussion.

In this method, through the message configuration control in the topic management page, the target topic content required to be deleted can be selected in the topic management page of the target topic, and the target topic content can be linked out of the topic management page of the target topic, which facilitates the organization and improvement of the topic content under the target topic for unified browsing, and improves the management efficiency and the user communication experience.

Furthermore, the method further includes: in response to the selection operation for the target topic content in the topic management page, deleting a topic tag of the target topic content in the group chat content display area.

That is to say, not only will the target topic content in the topic management page of the target topic be deleted, but in order to enable the group member to learn in the group chat content display area that the update of the target topic content is to delete the topic content that is not under the target topic. When the user selects the target topic content in the topic management page, the topic tag of the target topic in the target topic content will also be deleted in the group chat content display area to indicate that the target topic content is no longer the topic content under the target topic, further improving the topic management efficiency in the group chat.

In order to enable the group member to be reminded to quickly enter and participate in the discussion in time, after the step of displaying the reminder message in the group chat content display area displayed by the terminal device of the group member to be reminded, the method further includes: in response to a click operation for the reminder message, displaying the topic management page of the target topic on the terminal device of the group member to be reminded.

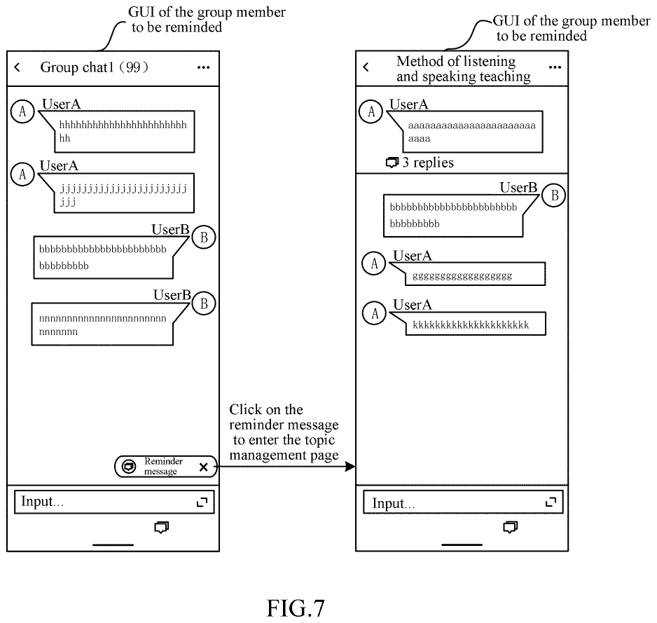

In actual implementation, the user uses the message configuration control to configure the configuration information of the target topic. When the reminder message is displayed in the group chat content display area provided by the terminal device of the group member to be reminded, as shown in FIG. 7, the user can click the reminder message displayed in the group chat content display area (corresponding to the click operation for the reminder message), and the currently displayed interface can be switched to the topic management page of the target topic, as shown in FIG. 7, the topic management page (the page on the right side of FIG. 7) in this case includes the topic name “Method of listening and speaking teaching” and the topic content “aaaa . . . ”, and the number of replied messages will also be displayed below the topic content, in this case, the topic management page displays three pieces of topic content about the target topic, and the group member to be reminded can quickly send and receive the topic content about the target topic on this page.

In this method, the group member to be reminded can directly click on the reminder message to quickly enter and participate in the discussion of the target topic in a timely manner, which is convenient and fast, reduces the operation path, allows easy participation in the discussion of the target topic, improves the communication efficiency, simplifies the operation process, and provides the user with the good communication experience.

In addition, the method further includes: in response to the click operation for the reminder message, generating the topic tag of the target topic in an input box displayed on the terminal device of the group member to be reminded.

In another implementation, after the group member to be reminded clicks the reminder message, the group chat content display area is displayed on the terminal device of the group member to be reminded, and the topic tag of the target topic is generated in the input box of the input area provided by the graphical user interface, to facilitate the group member to be reminded to directly receive and send the topic content of the target topic in the display interface of the group chat content display area. In this method, the group member to be reminded can directly click the reminder message, that is, the topic tag of the target topic is generated in the input box, and the topic content is directly entered in the input box, so as to quickly enter and participate in the discussion of the target topic in time, which is convenient and fast, reduces the operation path, allows easy participation in the discussion of the target topic, improves the communication efficiency, simplifies the operation process, and provides the user with the good communication experience.

In order to further improve the user's communication experience and avoid interfering with other operations of the user, the method further includes: in response to a deletion operation for the reminder message, canceling the display of the reminder message.

In actual implementation, the close control in the reminder bubble (i.e. the reminder message mentioned above) can be clicked to delete the reminder message, the display of the reminder message including the topic name or the reminder message including the topic name and the remaining discussion duration near the input box at the bottom of the group chat content display area is canceled.

If the user does not actively close the reminder message, the display of the reminder message can be canceled according to the remaining discussion time of the target topic. Specifically, if the creator does not configure the discussion time of the target topic, the system will set the discussion time of the target topic by default, such as one day, one month, etc., which can be set according to actual needs. In this case, when the remaining discussion time of the target topic set by the system by default is zero, the display of the reminder message will be canceled. If the topic creator configures the remaining discussion time of the target topic, in this case, the group chat interface of the designated group member will usually only display the reminder message for the remaining discussion duration of the target topic, which includes the topic name and the remaining discussion time. When the remaining discussion time of the target topic is zero, the display of the reminder message will be canceled.

In this method, the user can cancel the display of the reminder message by clicking, or the display of the reminder message can be canceled until the remaining discussion time of the target topic reaches zero, thereby preventing the reminder message from interfering with other normal operations of the user.

Generally, the topic content under the target topic created in the group chat is open to all group members, that is, each group member can launch the management page of the target topic and click to view the topic content. However, the topic content under some topics may involve confidential information, and there is a demand that it is not desired other group members except the designated group members see the topic content under the topic, and participate in this topic.

The configuration control includes a group chat configuration control, which is used to create a discussion group for the target topic. An implementation of in response to the configuration operation for the configuration control, obtaining the configuration information for the target topic, and configuring the target topic according to the configuration information is: in response to the configuration operation for the group chat configuration control, obtaining the configuration information of the discussion group for the target topic; and creating the discussion group for the target topic according to the configuration information of the discussion group for the target topic, and the configuration information of the discussion group for the target topic includes at least one of: a name of the discussion group, or a designated group member of the discussion group. The designated group member of the discussion group can be a pre-configured group member, or a group member who sends the topic content of the target topic.

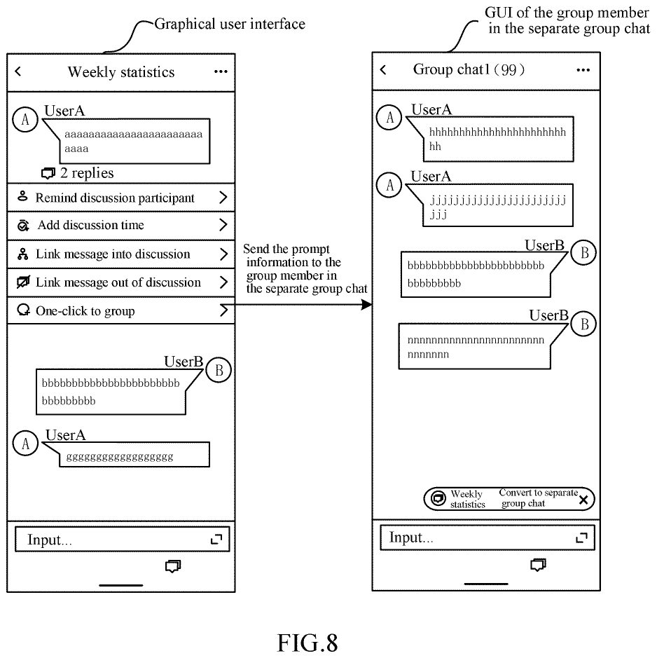

In actual implementation, the group chat configuration control in the target topic management page can be clicked, as shown in FIG. 8, the name of the group chat configuration control is “One-click to group”. In an implementation, a pop-up window usually appears with the display of a button with the word “Cancel” or “Confirm”, which can cancel or complete the conversion of the current topic content and group members about the target topic into the discussion group. A group name of the discussion group is the target topic, and the group members of the discussion group are the designated group members who participate in the discussion of the target topic.

When it is confirmed to convert the current target topic into the discussion group, the name of the currently discussed target topic is used as the group name of the discussion group, and the currently configured designated group members who participate in the discussion of the target topic are used as the group members of the discussion group.

In an implementation, prompt information for the discussion group is generated, and the prompt information includes the topic name of the target topic, such as “Weekly statistics” as shown in FIG. 8, which is used to prompt the group member in the discussion group that the discussion on the topic of “Weekly statistics” has been converted into the discussion group. The prompt information is then sent to the terminal device of the group member in the discussion group. When the terminal device of the group member in the discussion group receives the prompt information, the prompt information is displayed near the input box at the bottom of the group chat content display area of the terminal device of the group member in the discussion group, including the discussion icon, the topic name of the target topic “Weekly statistics”, “Convert into discussion group” for prompting and the close control (corresponding to the “×” in FIG. 8). The group member in the discussion group can learn from the content in the prompt information for the discussion group that the discussion group has been created for the target topic “Weekly statistics” in which he/she participates in the discussion.

In this method, if it is not desired that other members in the group chat see and participate in the discussion of the target topic, the group chat configuration control in the topic management page can be used to convert the discussion for the target topic into the discussion group, thereby ensuring the confidentiality of the topic discussion, facilitating the management of the topic creator, and improving the efficiency of topic management.

In an implementation, in order to make it more convenient for the user to view and participate in the discussion, in response to a click operation for the prompt information for the discussion group, a group chat page of the discussion group is displayed.

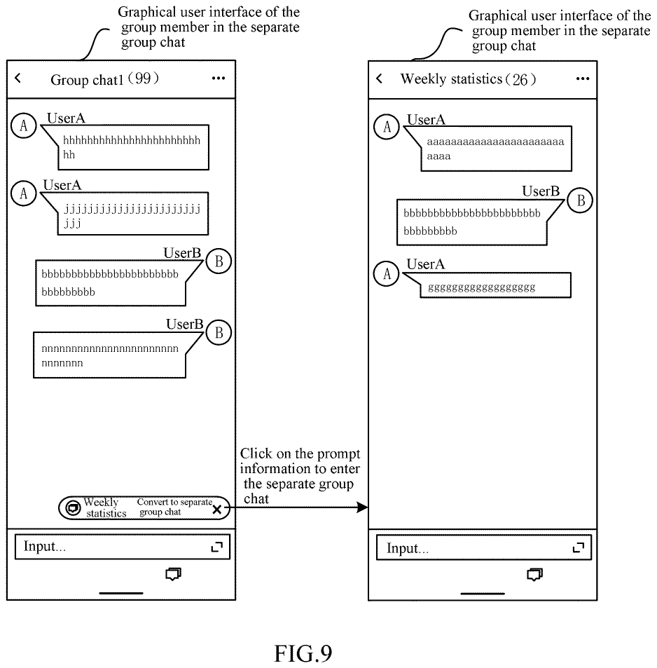

In actual implementation, as shown in FIG. 9, after the prompt information is displayed on the group chat interface of the group member of the discussion group, the group member of the discussion group can learn from the prompt information that a user has created the discussion group on the target topic. In this case, if the group member of the discussion group wants to check the situation of the discussion group, he/she can directly click on the prompt information displayed on the current group chat interface, and the group chat page of the discussion group will be displayed in the graphical user interface, as shown in FIG. 9, an upper area of the discussion group displays the topic name of the previous target topic discussion “Weekly statistics” and the number of designated group members “26”, and also displays the discussion messages that have been sent before the creation of the discussion group.

In this method, the group member of the discussion group can directly click on the prompt information in the interface of the group chat content display area to quickly and conveniently view the group chat page of the discussion group and participate in the chat of the discussion group, providing the user with the good communication experience.

An implementation of displaying the topic content in the group chat content display area in response to the creation operation of the target topic in the above step S202 is described below.

A content input area is provided through the graphical user interface, and the content input area includes an input box and a topic creation control; in response to a creation operation for the topic creation control, the topic tag of the target topic is generated; in response to an input operation for the input box, content to be sent is obtained; and in response to a confirmation operation for a sending control in the content input area, the topic content with the topic tag is sent to the group chat content display area for display.

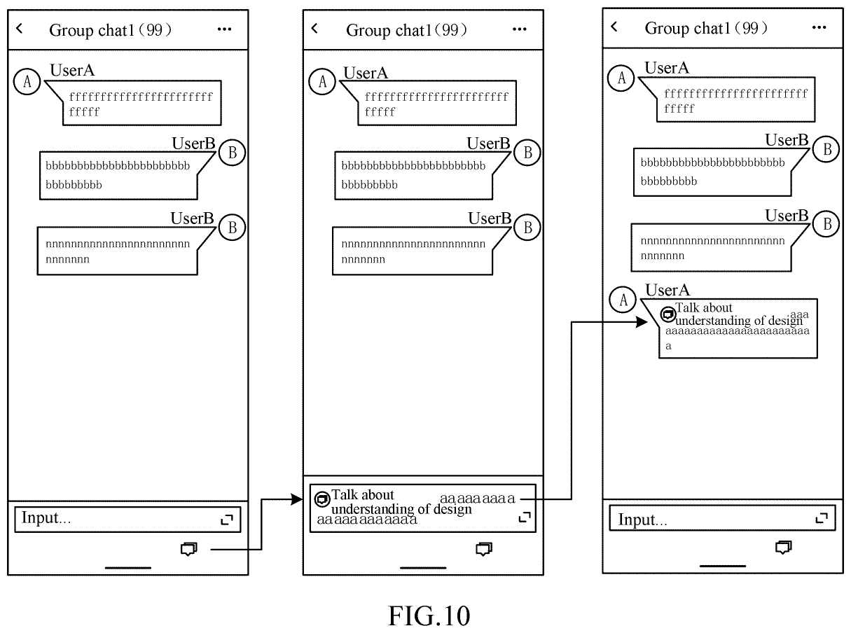

In order to enable the group member to quickly create the target topic in the group chat, the content input area is provided through the graphical user interface, and the content input area includes the input box and the topic creation control. As shown in FIG. 10, the input box and the topic creation control (such as the discussion icon below the input box in FIG. 10) are displayed at the bottom of the group chat content display area. The discussion icon can be clicked to update the input box. As shown in FIG. 10, when the discussion pattern (i.e., the above-mentioned topic creation control) is not clicked, there is a prompt “input . . . ” in the input box. The discussion icon is displayed in the input box after the update, and the topic name of the target topic can be entered after the discussion icon, such as “Talk about understanding of design” as shown in FIG. 10. The input of the topic name is completed with the pressing of the space bar to end, and the topic tag of the target topic can be generated. The topic content of the target topic is continued to be entered after the space, such as “aaaa . . . ” as shown in FIG. 10, to complete the input of the topic content, that is, the input operation for the input box is completed to obtain the content to be sent (such as the content in the input box in the second graphical user interface in FIG. 10). Finally, the sending control (such as the Enter key) in the content input area is clicked to send the topic tag of the target topic and the content to be sent to the group chat content display area for display.

In this method, through the input box and the topic creation control in the content input area provided by the graphical user interface, the topic content with the topic tag of the target topic is inputted and generated, the target topic can be created and the topic content with the tag can be displayed in the group chat display area.

In addition, an implementation of the step of generating the topic tag of the target topic in response to the creation operation for the topic creation control is: in response to the creation operation for the topic creation control, generating the topic tag of the target topic in the input box.

Specifically, in response to a click operation for the topic creation control, a tag pattern is generated in the input box, and in response to an input operation for the input box, the topic tag of the target topic is generated in the input box, the topic tag includes the tag pattern and the topic name of the target topic.

In order to avoid the problem that the group member finds that the target topic has not been created after sending the topic content in the target group, and needs to re-create the target topic, another implementation of displaying the topic content with the topic tag of the target topic in the group chat content display area in response to the creation operation of the target topic in the above step S202 is:
in response to a selection operation for the target content displayed in the group chat content display area, displaying an operation panel, and the operation panel includes a topic creation control; in response to a selection operation for the topic creation control, creating the topic tag of the target topic for the target content, and obtaining the topic content with the topic tag of the target topic; and displaying the topic content with the topic tag of the target topic in the group chat content display area.

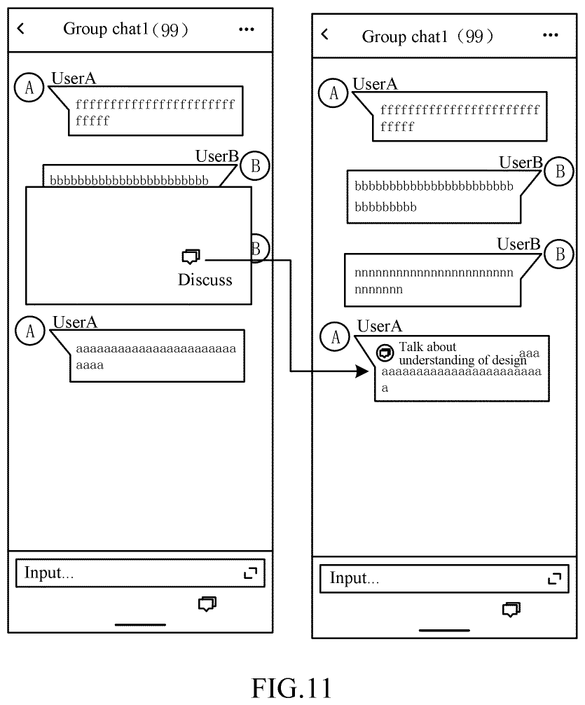

The target content is a group chat message sent by a group member of the target group. In actual implementation, right-click can be performed with the mouse, or the target content (such as “aaaa . . . ” as shown in FIG. 11) displayed in the group chat content display area is long-pressed, and then the operation panel will be displayed in the vicinity of the target content display area. There are multiple controls in the operation panel, including the topic creation control. The topic creation control (such as the discussion icon as shown in FIG. 11) in the operation panel is clicked to automatically create the topic tag of the target topic for the target content. For example, the first ten words of the target content are determined as the topic name in the topic tag. Alternatively, a topic name input box can be displayed in the vicinity, the user can enter the topic name of the target topic in this input box, and then select “Cancel” or “Confirm” below the input box to cancel or complete the topic creation for the target content. When the topic creation for the target message is determined, the topic content with the topic tag of the target topic is obtained; and the topic content with the topic tag of the target topic is displayed in the group chat content display area, that is, the topic name of the target topic is added at the beginning of the target content, such as “Talk about understanding of design aaa . . . ” as shown in FIG. 11, and the target content can be converted into the topic content under the target topic.

It should be noted that in this implementation, the topic creator who creates the target topic by right-clicking the target content may be a group member in the target group who previously sent the target content, or may be another group member in the target group.

In this method, through the operation for the target content, the topic tag for the target content can be created, and the target content can be converted into the topic content under the target topic, so that the user can create the topic more conveniently and quickly.

In order to further improve the user's communication experience, an implementation of displaying the topic management page of the target topic in response to the viewing operation for the target topic in the above step S104 is described below.

In response to the viewing operation for the topic tag, a preview page of the target topic is displayed in the group chat content display area, the preview page is configured to display at least part of the topic content under the target topic and a message input box, and the message input box includes the topic tag of the target topic; and in response to an expansion operation for the preview page, the topic management page of the target topic is displayed.

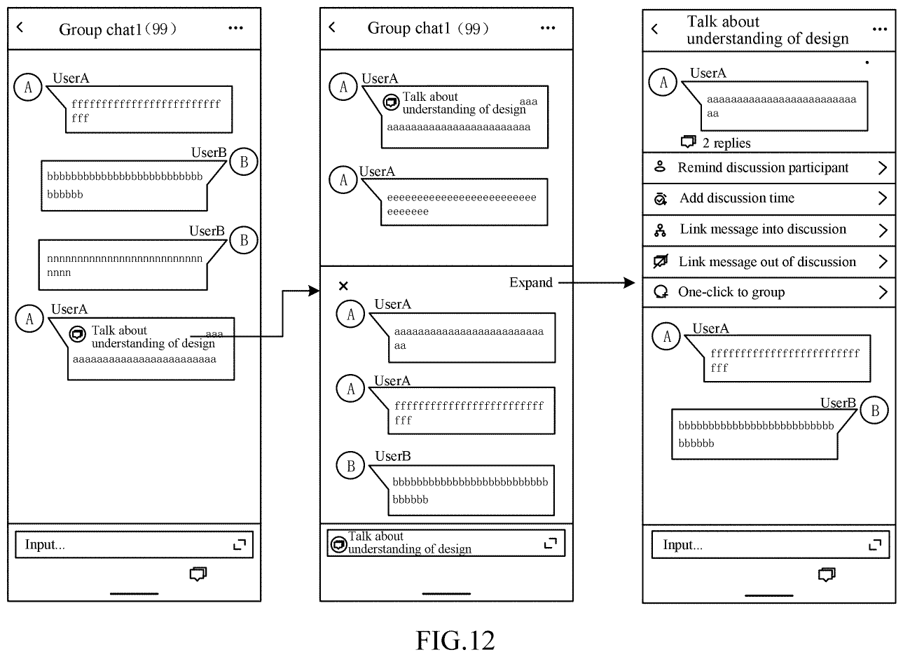

In actual implementation, the topic tag of the target topic in the group chat content display area can be clicked, such as “Talk about understanding of design” as shown in FIG. 12. Further, the preview page of the target topic is displayed, as shown in FIG. 12, a close control (corresponding to “×” in FIG. 12) is displayed in the upper left corner of the preview page, and a button with the word “Expand” is displayed in the upper right corner of the preview page. A second message input box below is pre-filled with the discussion icon and the topic name of the target topic “Talk about understanding of design”, and the topic content is continued to be entered in the following, and a first discussion message can be directly sent by pressing the Enter key. If “Expand” in the upper right corner is clicked, the topic management page of the target topic can be entered.

It should be noted that, as shown in FIG. 12, the topic management page for the target topic is displayed in the graphical user interface, including the topic name of the target topic “Talk about understanding of design”, the topic content displayed above, the number of replies for the target topic, and the configuration control and the topic content display area. In this method, by clicking the topic tag in the group chat content display area, the preview page of the target topic is displayed for centralized browsing. “Expand” is clicked in the preview page to view the topic management page of the target topic, which reduces the operation path of viewing the discussion message of the topic.

In order to improve the management efficiency and facilitate the user to view the topic, the graphical user interface also includes a setting control, and the method further includes: providing a discussion viewing control through the graphical user interface; and in response to a selection operation for the discussion viewing control, displaying at least part of topics related to the target group.

Specifically, in response to the click operation for the discussion viewing control, a settings page is displayed, the settings page includes a discussion control. In response to a click operation for the discussion control, at least part of topics related to the target group is displayed, including the topic name of the topic and the creation time of the topic, the group member information, and the discussion time, etc. In response to a click operation for the topic name of the target topic, the topic management page of the target topic is displayed.

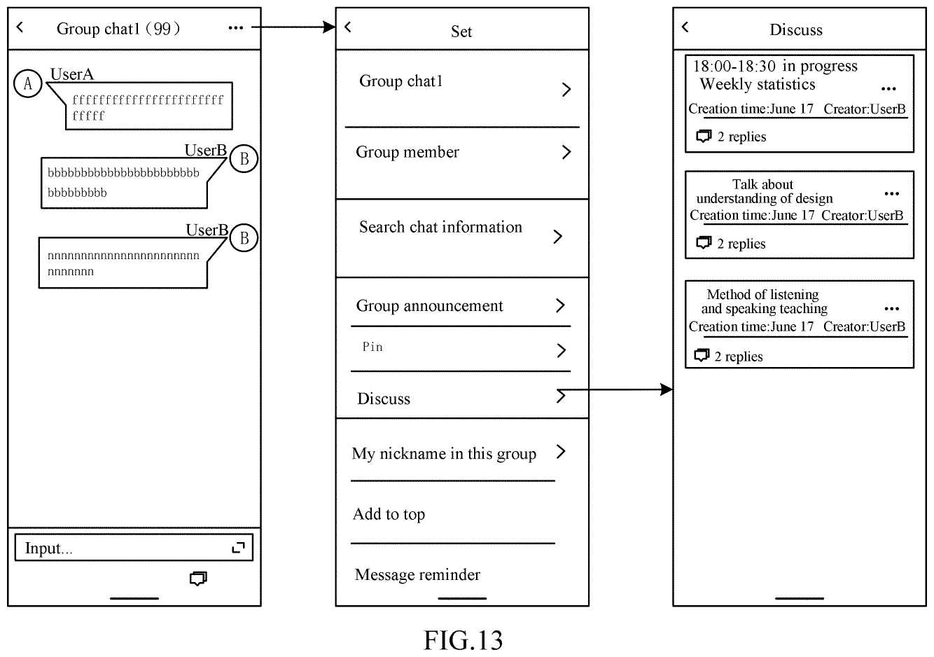

In actual implementation, the discussion viewing control is clicked, such as “ . . . ” as shown in FIG. 13, and the setting page of the target group is displayed in the graphical user interface, including the discussion control, such as a control with the word “Discussion” as shown in FIG. 13. The discussion control is clicked to display all historical topics and current topics of discussion, which can be displayed as a topic list. Each historical topic box includes the topic name, such as “Weekly statistics”, “Talk about understanding of design”, “Method of listening and speaking teaching” as shown in FIG. 13, and also includes the creation time “June 17”, the group member information “Creator: user B”, and the discussion time “18:00-18:30 in progress”. If the user wants to view the discussion message of the target topic, as shown in FIG. 13, the user can click on the topic name of the target topic in the topic list, or perform a page display operation for the “ . . . ” in the upper right corner to display the topic management page of the target topic. In addition, at least some of the topics are topics under discussion, that is, topics currently under discussion, or topics whose remaining discussion duration is not zero.

In this method, by clicking on the discussion viewing control, the group chat setting page is displayed, at least part of the topics related to the target group is displayed, and then the target topic is viewed, and the topic management page of the target topic is displayed.

In order to further improve the user's communication experience, the method further includes: in response to a blocking operation for a designated topic among the at least part of topics displayed, cancelling display of the designated topic, and blocking topic content with a topic tag of the designated topic in the group chat content display area.

In actual implementation, the designated topic among the displayed topics can be clicked, such as the “ . . . ” icon in the upper right corner of the topic name of the designated topic, as shown in FIG. 13, and a blocking option is selected to cancel the display of the designated topic, and at the same time, the topic content with the topic tag of the designated topic is blocked in the group chat content display area. In this method, by blocking the target topic, it is possible to filter the historical topics to display the topic in which the user participates in the discussion, and the topic content with the topic tag of the designated topic is blocked in the group chat content display area, thereby realizing the function of message noise reduction and improving the user's communication experience.

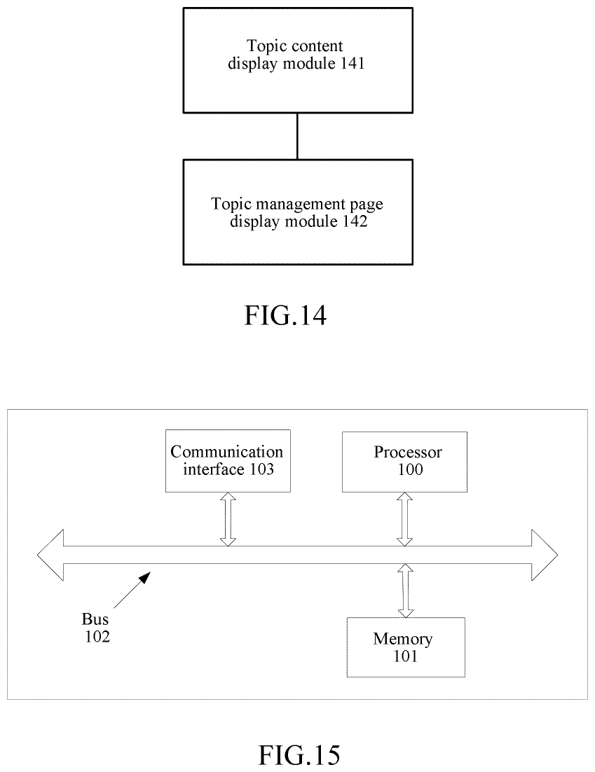

Corresponding to the above method embodiments, reference is made to a device for managing a group chat message shown in FIG. 14. A graphical user interface is provided by a terminal device, and the graphical user interface includes a group chat content display area, and the group chat content display area is configured to display content sent by a group member in a target group. The device includes:
a topic content display module 141, configured to, in response to a creation operation of a target topic, display topic content with a topic tag of the target topic in the group chat content display area; and
a topic management page display module 142, configured to, in response to a viewing operation for the topic tag, display a topic management page of the target topic, wherein the topic management page is configured to display at least part of the topic content under the target topic.

In the device for managing the group chat message, in response to the creation operation of the target topic, the topic content with the target topic is displayed in the group chat content display area; and in response to the viewing operation for the topic tag, the topic management page of the target topic is displayed, and the topic management page is configured to display at least part of the topic content under the target topic. In this way, the group member of the target group can create different topics for discussion in the group chat interface. For different topics, not only can you distinguish discussion messages of different topics by topic tags, but you can also centrally view discussion messages about the topic through the topic management page. The interruption of irrelevant messages is avoided, and branch discussions of different topics can be completed without creating a new group. In addition, the topic content can be managed on the topic management page, which improves the communication efficiency and group management efficiency for different topics in the group chat, and also improves the user's communication experience.

In some embodiments, the topic content display module is further configured to: provide a content input area through the graphical user interface, wherein the content input area includes an input box and a topic creation control; in response to the creation operation for the topic creation control, generate the topic tag of the target topic; in response to an input operation for the input box, obtain content to be sent; and in response to a confirmation operation for a sending control in the content input area, send the topic content with the topic tag of the target topic to the group chat content display area for display.

In some embodiments, the topic content display module is further configured to, in response to the creation operation for the topic creation control, generate the topic tag of the target topic in the input box.

In some embodiments, the topic content display module is further configured to: in response to a selection operation for target content displayed in the group chat content display area, display an operation panel, wherein the operation panel includes a topic creation control; in response to a selection operation for the topic creation control, create the topic tag of the target topic for the target content, and obtain the topic content with the topic tag of the target topic; and display the topic content with the topic tag of the target topic in the group chat content display area.

In some embodiments, the device for managing the group chat message further includes a scrolling module, configured to, in response to a sliding operation for the topic management page, control the topic content in the topic management page to scroll.

In some embodiments, the topic management page further includes a configuration control, and the device includes a configuration module, configured to: in response to a configuration operation for the configuration control, obtain configuration information for the target topic; and configure the target topic according to the configuration information.

In some embodiments, the configuration control includes a message configuration control, and the configuration module is further configured to: in response to the configuration operation for the message configuration control, display the group chat content display area; in response to a selection operation for target content in the group chat content display area, use the target content as the configuration information; and add the target content to the topic management page of the target topic.

In some embodiments, the configuration module is further configured to: in response to the selection operation for the target content in the group chat content display area, add the topic tag of the target topic to the target content in the group chat content display area.

In some embodiments, the configuration control includes a message configuration control, and the configuration module is further configured to: in response to the configuration operation for the message configuration control, control the topic content in the topic management page to enter a selectable state; in response to a selection operation for target topic content in the topic management page, use the target topic content as the configuration information; and delete the target topic content from the topic management page of the target topic.

In some embodiments, the configuration module is further configured to: in response to the selection operation for the target topic content in the topic management page, delete a topic tag of the target topic content in the group chat content display area.

In some embodiments, the configuration control includes a reminder configuration control, and the configuration module is further configured to: in response to the configuration operation for the reminder configuration control, obtain the configuration information for the target topic; and display, according to the configuration information, a reminder message for the target topic in the group chat content display area.

In some embodiments, the reminder configuration control includes a first reminder configuration control, and the configuration module is further configured to: in response to the configuration operation for the first reminder configuration control, determine a group member to be reminded for the target topic, wherein the configuration information includes the group member to be reminded; and send the reminder message for the target topic to the group member to be reminded to cause the group chat content display area displayed on a terminal device of the group member to be reminded to display the reminder message.

In some embodiments, the configuration module is further configured to: in response to a click operation for the reminder message, display the topic management page of the target topic on the terminal device of the group member to be reminded.

In some embodiments, the configuration module is further configured to: in response to a click operation for the reminder message, generate the topic tag of the target topic in an input box displayed on the terminal device of the group member to be reminded.

In some embodiments, the reminder configuration control includes a second reminder configuration control, and the configuration module is further configured to: in response to the configuration operation for the second reminder configuration control, determine a discussion duration for the target topic, wherein the configuration information includes the discussion duration; and display, according to the discussion duration, the reminder message for a remaining discussion duration of the target topic in the group chat content display area.

In some embodiments, the configuration module is further configured to: in response to the remaining discussion duration being equal to zero, hide the reminder message.

In some embodiments, the configuration control includes a group chat configuration control, and the configuration module is further configured to: in response to the configuration operation for the group chat configuration control, obtain the configuration information of a discussion group for the target topic; and create the discussion group for the target topic according to the configuration information of the discussion group for the target topic.

In some embodiments, the configuration information includes at least one of: a name of the discussion group, or a designated group member of the discussion group.

In some embodiments, the device for managing the group chat message further includes a topic display module, configured to: provide a discussion viewing control through the graphical user interface; and in response to a selection operation for the discussion viewing control, display at least part of topics related to the target group.

In some embodiments, the at least part of topics is a topic under discussion.

In some embodiments, the topic display module is further configured to: in response to a blocking operation for a designated topic among the displayed at least part of topics, cancel display of the designated topic, and blocking topic content with a topic tag of the designated topic in the group chat content display area.

In some embodiments, the topic management page display module is further configured to: in response to the viewing operation for the topic tag, display a preview page of the target topic in the group chat content display area, wherein the preview page is configured to display at least part of the topic content under the target topic and a message input box, and the message input box includes the topic tag of the target topic; and in response to an expansion operation for the preview page, display the topic management page of the target topic.

The device for managing the group chat message provided in the embodiments of the present disclosure has the same technical features as the method for managing the group chat message provided in the above embodiments, so it can also solve the same technical problems and achieve the same technical effects.

Embodiments of the present disclosure further provide an electronic device, including a processor and a memory. Machine executable instructions that can be executed by the processor are stored in the memory, and the processor executes the machine executable instructions to implement the method for managing the group chat message as described above. The electronic device can be a server or a terminal device.

As shown in FIG. 14, the electronic device includes a processor 100 and a memory 101. The memory 101 stores machine executable instructions that can be executed by the processor 100. The processor 100 executes the machine executable instructions to implement the method for managing the group chat message as described above. In the method, a graphical user interface is provided by a terminal device, the graphical user interface includes a group chat content display area, and the group chat content display area is configured to display content sent by a group member in a target group. The method includes the following steps:
in response to a creation operation of a target topic, displaying topic content with a topic tag of the target topic in the group chat content display area; and in response to a viewing operation for the topic tag, displaying a topic management page of the target topic, wherein the topic management page is configured to display at least part of the topic content under the target topic. In this method, the group member of the target group can create different topics for discussion in the group chat interface. For different topics, not only can you distinguish discussion messages of different topics by topic tags, but you can also centrally view discussion messages about the topic through the topic management page. The interruption of irrelevant messages is avoided, and branch discussions of different topics can be completed without creating a new group. In addition, the topic content can be managed on the topic management page, which improves the communication efficiency and group management efficiency for different topics in the group chat, and also improves the user's communication experience.

In some embodiments, in response to the creation operation of the target topic, displaying the topic content with the topic tag of the target topic in the group chat content display area includes: providing a content input area through the graphical user interface, wherein the content input area includes an input box and a topic creation control; in response to the creation operation for the topic creation control, generating the topic tag of the target topic; in response to an input operation for the input box, obtaining content to be sent; and in response to a confirmation operation for a sending control in the content input area, sending the topic content with the topic tag of the target topic to the group chat content display area for display. In this method, through the input box and the topic creation control in the content input area provided by the graphical user interface, the topic content with the topic tag of the target topic is inputted and generated, the target topic can be created and the topic content with the tag can be displayed in the group chat display area.

In some embodiments, in response to the creation operation for the topic creation control, generating the topic tag of the target topic includes: in response to the creation operation for the topic creation control, generating the topic tag of the target topic in the input box.

In some embodiments, in response to the creation operation of the target topic, displaying the topic content with the topic tag of the target topic in the group chat content display area includes: in response to a selection operation for target content displayed in the group chat content display area, displaying an operation panel, wherein the operation panel includes a topic creation control; in response to a selection operation for the topic creation control, creating the topic tag of the target topic for the target content, and obtaining the topic content with the topic tag of the target topic; and displaying the topic content with the topic tag of the target topic in the group chat content display area. In this method, through the operation for the target content, the topic tag for the target content can be created, and the target content can be converted into the topic content under the target topic, so that the user can create the topic more conveniently and quickly.

In some embodiments, the method for managing the group chat message may further include: in response to a sliding operation for the topic management page, controlling the topic content in the topic management page to scroll.

In some embodiments, the topic management page further includes a configuration control, and the method further includes: in response to a configuration operation for the configuration control, obtaining configuration information for the target topic; and configuring the target topic according to the configuration information. In this method, the target topic can be configured through the configuration control, which further improves the user's management efficiency of the discussion topic.

In some embodiments, the configuration control includes a message configuration control, and in response to the configuration operation for the configuration control, obtaining the configuration information for the target topic includes: in response to the configuration operation for the message configuration control, displaying the group chat content display area; and in response to a selection operation for target content in the group chat content display area, using the target content as the configuration information; configuring the target topic according to the configuration information includes: adding the target content to the topic management page of the target topic. In this method, through the message configuration control in the topic management page, the target content that is not under the target topic can be selected from the group chat content display area, and added to the topic management page of the target topic, which can organize and improve the discussion messages, aggregate the relevant content of the target topic to facilitate the user to browse. Moreover, the post-linking is a remedial measure for organizing the messages, which improves the management efficiency.

In some embodiments, the method for managing the group chat message may further include: in response to the selection operation for the target content in the group chat content display area, adding the topic tag of the target topic to the target content in the group chat content display area.

In some embodiments, the configuration control includes a message configuration control, and in response to the configuration operation for the configuration control, obtaining the configuration information for the target topic includes: in response to the configuration operation for the message configuration control, controlling the topic content in the topic management page to enter a selectable state; and in response to a selection operation for target topic content in the topic management page, using the target topic content as the configuration information; configuring the target topic according to the configuration information includes: deleting the target topic content from the topic management page of the target topic. In this method, through the message configuration control in the topic management page, the target topic content required to be deleted can be selected in the topic management page of the target topic, and the target topic content can be linked out of the topic management page of the target topic, which facilitates the organization and improvement of the topic content under the target topic for unified browsing, and improves the management efficiency and the user communication experience.

In some embodiments, the method for managing the group chat message may further include: in response to the selection operation for the target topic content in the topic management page, deleting a topic tag of the target topic content in the group chat content display area.

In some embodiments, the configuration control includes a reminder configuration control, and in response to the configuration operation for the configuration control, obtaining the configuration information for the target topic includes: in response to the configuration operation for the reminder configuration control, obtaining the configuration information for the target topic; configuring the target topic according to the configuration information includes: displaying, according to the configuration information, a reminder message for the target topic in the group chat content display area. In this method, the configuration information of the target topic is configured through the reminder configuration control on the topic management page, and then the reminder message is displayed in the group chat content display area, so that the group member can learn the configuration of the target topic in time, improving the communication efficiency and topic management efficiency.

In some embodiments, the reminder configuration control includes a first reminder configuration control, and in response to the configuration operation for the reminder configuration control, obtaining the configuration information for the target topic includes: in response to the configuration operation for the first reminder configuration control, determining a group member to be reminded for the target topic, wherein the configuration information includes the group member to be reminded; displaying, according to the configuration information, the reminder message for the target topic in the group chat content display area includes: sending the reminder message for the target topic to the group member to be reminded to cause the group chat content display area displayed on a terminal device of the group member to be reminded to display the reminder message. In this method, the group member to be reminded can be selected through the first reminder configuration control in the topic management page, and the reminder message can be sent to the group member to be reminded, so as to remind the group member to be reminded to participate in the discussion of the target topic, thereby improving the management efficiency, and providing the user with the good communication experience.

In some embodiments, the method for managing the group chat message may further include: in response to a click operation for the reminder message, displaying the topic management page of the target topic on the terminal device of the group member to be reminded.

In some embodiments, the method for managing the group chat message may further include: in response to a click operation for the reminder message, generating the topic tag of the target topic in an input box displayed on the terminal device of the group member to be reminded.

In some embodiments, the reminder configuration control includes a second reminder configuration control, and in response to the configuration operation for the reminder configuration control, obtaining the configuration information for the target topic includes: in response to the configuration operation for the second reminder configuration control, determining a discussion duration for the target topic, wherein the configuration information includes the discussion duration; displaying, according to the configuration information, the reminder message for the target topic in the group chat content display area includes: displaying, according to the discussion duration, the reminder message for a remaining discussion duration of the target topic in the group chat content display area. In this method, the discussion duration of the target topic can be selected through the second reminder configuration control in the topic management page, and the designated group member can be reminded to participate in the discussion of the target topic within the discussion time period, thereby standardizing the discussion duration and improving the user's communication experience.

In some embodiments, the method for managing the group chat message may further include: in response to the remaining discussion duration being equal to zero, hiding the reminder message.

In some embodiments, the configuration control includes a group chat configuration control; in response to the configuration operation for the configuration control, obtaining the configuration information for the target topic includes: in response to the configuration operation for the group chat configuration control, obtaining the configuration information of a discussion group for the target topic; configuring the target topic according to the configuration information includes: creating the discussion group for the target topic according to the configuration information of the discussion group for the target topic. In this method, if it is not desired that other members in the group chat see and participate in the discussion of the target topic, the group chat configuration control in the topic management page can be used to convert the discussion for the target topic into the discussion group, thereby ensuring the confidentiality of the topic discussion, facilitating the management of the topic creator, and improving the efficiency of topic management.

In some embodiments, the configuration information includes at least one of: a name of the discussion group, or a designated group member of the discussion group.

In some embodiments, the method for managing the group chat message may further include: providing a discussion viewing control through the graphical user interface; and in response to a selection operation for the discussion viewing control, displaying at least part of topics related to the target group. In this method, by clicking on the discussion viewing control, the group chat setting page is displayed, at least part of the topics related to the target group is displayed, and then the target topic is viewed, and the topic management page of the target topic is displayed.

In some embodiments, the at least part of topics is a topic under discussion.

In some embodiments, the method for managing the group chat message may further include: in response to a blocking operation for a designated topic among the displayed at least part of topics, cancelling display of the designated topic, and blocking topic content with a topic tag of the designated topic in the group chat content display area. In this method, by blocking the target topic, it is possible to filter the historical topics to display the topic in which the user participates in the discussion, and the topic content with the topic tag of the designated topic is blocked in the group chat content display area, thereby realizing the function of message noise reduction and improving the user's communication experience.

In some embodiments, in response to the viewing operation for the topic tag, displaying the topic management page of the target topic includes: in response to the viewing operation for the topic tag, displaying a preview page of the target topic in the group chat content display area, wherein the preview page is configured to display at least part of the topic content under the target topic and a message input box, and the message input box includes the topic tag of the target topic; and in response to an expansion operation for the preview page, displaying the topic management page of the target topic. In this method, by clicking the topic tag in the group chat content display area, the preview page of the target topic is displayed for centralized browsing. “Expand” is clicked in the preview page to view the topic management page of the target topic, which reduces the operation path of viewing the discussion message of the topic.

Furthermore, the electronic device shown in FIG. 14 further includes a bus 102 and a communication interface 103. The processor 100, the communication interface 103 and the memory 101 are connected via the bus 102.

The memory 101 may include a high-speed random access memory (RAM), and may also include a non-volatile memory, such as, at least one disk storage. The communication connection between the system network element and at least one other network element is realized through at least one communication interface 103 (which can be wired or wireless), and the Internet, the wide area network, the local area network, the metropolitan area network, etc. can be used. The bus 102 can be an ISA bus, a PCI bus or an EISA bus, etc. The bus can be divided into an address bus, a data bus, a control bus, etc. For ease of representation, only one bidirectional arrow is used in FIG. 14, but it does not mean that there is only one bus or one type of bus.

The processor 100 may be an integrated circuit chip with signal processing capabilities. In an implementation process, each step of the above method can be completed by a hardware integrated logic circuit or software instructions in the processor 100. The processor 100 may be a general-purpose processor, including a central processing unit (CPU), a network processor (NP), etc.; it can also be a digital signal processor (DSP), an application specific integrated circuit (ASIC), a field-programmable gate array (FPGA) or other programmable logic devices, discrete gates or transistor logic devices, discrete hardware components. The disclosed methods, steps and logic block diagrams in embodiments of the present disclosure can be implemented or executed. The general-purpose processor can be a microprocessor or the processor can also be any conventional processor, etc. The steps of the method disclosed in conjunction with the embodiments of the present disclosure can be directly embodied as a hardware decoding processor for execution, or a combination of hardware and software modules in the decoding processor for execution. The software module may be located in a storage medium mature in the art, such as a random access memory, a flash memory, a read-only memory, a programmable read-only memory, or an electrically erasable programmable memory, a register, etc. The storage medium is located in the memory 101, and the processor 100 reads the information in the memory 101 and completes the steps of the method of the above embodiments in combination with its hardware.

Embodiments of the present disclosure further provide a machine-readable storage medium having machine-executable instructions stored thereon, which, when invoked and executed by a processor, cause the processor to implement the method for managing the group chat message as described above. In the method, a graphical user interface is provided by a terminal device, the graphical user interface includes a group chat content display area, and the group chat content display area is configured to display content sent by a group member in a target group. The method includes the following steps:
in response to a creation operation of a target topic, displaying topic content with a topic tag of the target topic in the group chat content display area; and in response to a viewing operation for the topic tag, displaying a topic management page of the target topic, wherein the topic management page is configured to display at least part of the topic content under the target topic. In this method, the group member of the target group can create different topics for discussion in the group chat interface. For different topics, not only can you distinguish discussion messages of different topics by topic tags, but you can also centrally view discussion messages about the topic through the topic management page. The interruption of irrelevant messages is avoided, and branch discussions of different topics can be completed without creating a new group. In addition, the topic content can be managed on the topic management page, which improves the communication efficiency and group management efficiency for different topics in the group chat, and also improves the user's communication experience.

In some embodiments, in response to the creation operation of the target topic, displaying the topic content with the topic tag of the target topic in the group chat content display area includes: providing a content input area through the graphical user interface, wherein the content input area includes an input box and a topic creation control; in response to the creation operation for the topic creation control, generating the topic tag of the target topic; in response to an input operation for the input box, obtaining content to be sent; and in response to a confirmation operation for a sending control in the content input area, sending the topic content with the topic tag of the target topic to the group chat content display area for display. In this method, through the input box and the topic creation control in the content input area provided by the graphical user interface, the topic content with the topic tag of the target topic is inputted and generated, the target topic can be created and the topic content with the tag can be displayed in the group chat display area.

In some embodiments, in response to the creation operation for the topic creation control, generating the topic tag of the target topic includes: in response to the creation operation for the topic creation control, generating the topic tag of the target topic in the input box.

In some embodiments, in response to the creation operation of the target topic, displaying the topic content with the topic tag of the target topic in the group chat content display area includes: in response to a selection operation for target content displayed in the group chat content display area, displaying an operation panel, wherein the operation panel includes a topic creation control; in response to a selection operation for the topic creation control, creating the topic tag of the target topic for the target content, and obtaining the topic content with the topic tag of the target topic; and displaying the topic content with the topic tag of the target topic in the group chat content display area. In this method, through the operation for the target content, the topic tag for the target content can be created, and the target content can be converted into the topic content under the target topic, so that the user can create the topic more conveniently and quickly.

In some embodiments, the method for managing the group chat message may further include: in response to a sliding operation for the topic management page, controlling the topic content in the topic management page to scroll.

In some embodiments, the topic management page further includes a configuration control, and the method further includes: in response to a configuration operation for the configuration control, obtaining configuration information for the target topic; and configuring the target topic according to the configuration information. In this method, the target topic can be configured through the configuration control, which further improves the user's management efficiency of the discussion topic.

In some embodiments, the configuration control includes a message configuration control, and in response to the configuration operation for the configuration control, obtaining the configuration information for the target topic includes: in response to the configuration operation for the message configuration control, displaying the group chat content display area; and in response to a selection operation for target content in the group chat content display area, using the target content as the configuration information; configuring the target topic according to the configuration information includes: adding the target content to the topic management page of the target topic. In this method, through the message configuration control in the topic management page, the target content that is not under the target topic can be selected from the group chat content display area, and added to the topic management page of the target topic, which can organize and improve the discussion messages, aggregate the relevant content of the target topic to facilitate the user to browse. Moreover, the post-linking is a remedial measure for organizing the messages, which improves the management efficiency.

In some embodiments, the method for managing the group chat message may further include: in response to the selection operation for the target content in the group chat content display area, adding the topic tag of the target topic to the target content in the group chat content display area.

In some embodiments, the configuration control includes a message configuration control, and in response to the configuration operation for the configuration control, obtaining the configuration information for the target topic includes: in response to the configuration operation for the message configuration control, controlling the topic content in the topic management page to enter a selectable state; and in response to a selection operation for target topic content in the topic management page, using the target topic content as the configuration information; configuring the target topic according to the configuration information includes: deleting the target topic content from the topic management page of the target topic. In this method, through the message configuration control in the topic management page, the target topic content required to be deleted can be selected in the topic management page of the target topic, and the target topic content can be linked out of the topic management page of the target topic, which facilitates the organization and improvement of the topic content under the target topic for unified browsing, and improves the management efficiency and the user communication experience.

In some embodiments, the method for managing the group chat message may further include: in response to the selection operation for the target topic content in the topic management page, deleting a topic tag of the target topic content in the group chat content display area.

In some embodiments, the configuration control includes a reminder configuration control, and in response to the configuration operation for the configuration control, obtaining the configuration information for the target topic includes: in response to the configuration operation for the reminder configuration control, obtaining the configuration information for the target topic; configuring the target topic according to the configuration information includes: displaying, according to the configuration information, a reminder message for the target topic in the group chat content display area. In this method, the configuration information of the target topic is configured through the reminder configuration control on the topic management page, and then the reminder message is displayed in the group chat content display area, so that the group member can learn the configuration of the target topic in time, improving the communication efficiency and topic management efficiency.

In some embodiments, the reminder configuration control includes a first reminder configuration control, and in response to the configuration operation for the reminder configuration control, obtaining the configuration information for the target topic includes: in response to the configuration operation for the first reminder configuration control, determining a group member to be reminded for the target topic, wherein the configuration information includes the group member to be reminded; displaying, according to the configuration information, the reminder message for the target topic in the group chat content display area includes: sending the reminder message for the target topic to the group member to be reminded to cause the group chat content display area displayed on a terminal device of the group member to be reminded to display the reminder message. In this method, the group member to be reminded can be selected through the first reminder configuration control in the topic management page, and the reminder message can be sent to the group member to be reminded, so as to remind the group member to be reminded to participate in the discussion of the target topic, thereby improving the management efficiency, and providing the user with the good communication experience.

In some embodiments, the method for managing the group chat message may further include: in response to a click operation for the reminder message, displaying the topic management page of the target topic on the terminal device of the group member to be reminded.

In some embodiments, the method for managing the group chat message may further include: in response to a click operation for the reminder message, generating the topic tag of the target topic in an input box displayed on the terminal device of the group member to be reminded.

In some embodiments, the reminder configuration control includes a second reminder configuration control, and in response to the configuration operation for the reminder configuration control, obtaining the configuration information for the target topic includes: in response to the configuration operation for the second reminder configuration control, determining a discussion duration for the target topic, wherein the configuration information includes the discussion duration; displaying, according to the configuration information, the reminder message for the target topic in the group chat content display area includes: displaying, according to the discussion duration, the reminder message for a remaining discussion duration of the target topic in the group chat content display area. In this method, the discussion duration of the target topic can be selected through the second reminder configuration control in the topic management page, and the designated group member can be reminded to participate in the discussion of the target topic within the discussion time period, thereby standardizing the discussion duration and improving the user's communication experience.

In some embodiments, the method for managing the group chat message may further include: in response to the remaining discussion duration being equal to zero, hiding the reminder message.

In some embodiments, the configuration control includes a group chat configuration control; in response to the configuration operation for the configuration control, obtaining the configuration information for the target topic includes: in response to the configuration operation for the group chat configuration control, obtaining the configuration information of a discussion group for the target topic; configuring the target topic according to the configuration information includes: creating the discussion group for the target topic according to the configuration information of the discussion group for the target topic. In this method, if it is not desired that other members in the group chat see and participate in the discussion of the target topic, the group chat configuration control in the topic management page can be used to convert the discussion for the target topic into the discussion group, thereby ensuring the confidentiality of the topic discussion, facilitating the management of the topic creator, and improving the efficiency of topic management.

In some embodiments, the configuration information includes at least one of: a name of the discussion group, or a designated group member of the discussion group.

In some embodiments, the method for managing the group chat message may further include: providing a discussion viewing control through the graphical user interface; and in response to a selection operation for the discussion viewing control, displaying at least part of topics related to the target group. In this method, by clicking on the discussion viewing control, the group chat setting page is displayed, at least part of the topics related to the target group is displayed, and then the target topic is viewed, and the topic management page of the target topic is displayed.

In some embodiments, the at least part of topics is a topic under discussion.

In some embodiments, the method for managing the group chat message may further include: in response to a blocking operation for a designated topic among the displayed at least part of topics, cancelling display of the designated topic, and blocking topic content with a topic tag of the designated topic in the group chat content display area. In this method, by blocking the target topic, it is possible to filter the historical topics to display the topic in which the user participates in the discussion, and the topic content with the topic tag of the designated topic is blocked in the group chat content display area, thereby realizing the function of message noise reduction and improving the user's communication experience.

In some embodiments, in response to the viewing operation for the topic tag, displaying the topic management page of the target topic includes: in response to the viewing operation for the topic tag, displaying a preview page of the target topic in the group chat content display area, wherein the preview page is configured to display at least part of the topic content under the target topic and a message input box, and the message input box includes the topic tag of the target topic; and in response to an expansion operation for the preview page, displaying the topic management page of the target topic. In this method, by clicking the topic tag in the group chat content display area, the preview page of the target topic is displayed for centralized browsing. “Expand” is clicked in the preview page to view the topic management page of the target topic, which reduces the operation path of viewing the discussion message of the topic.

The method and device for managing the group chat message, the electronic device and the computer program product of the storage medium provided in embodiments of the present disclosure include a non-transitory computer-readable storage medium storing program codes. Instructions included in the program codes can be configured to execute the method described in the previous method embodiments. For the specific implementation, reference can be made to the method embodiments, which will not be repeated here.

Those skilled in the art can clearly understand that, for the convenience and brevity of description, the specific working process of the system and device described above can refer to the corresponding process in the aforementioned method embodiments, which will not be repeated here.

In addition, in the description of embodiments of the present disclosure, unless otherwise clearly specified and limited, the terms “installed”, “connected”, and “coupled” should be understood in a broad sense, for example, it can be a fixed connection, a detachable connection, or an integral connection; it can be a mechanical connection or an electrical connection; it can be a direct connection, or it can be indirectly connected through an intermediate medium, or it can be the internal communication of two components. For those skilled in the art, the specific meanings of the above terms in the present disclosure can be understood according to specific circumstances.

The functions may be stored in a computer readable storage medium if implemented in the form of a software functional unit and sold or used as a standalone product. Based on such understanding, the technical solutions of the present disclosure substantially, or the part contributing to the prior art, or all or a part of the technical solutions may be implemented in the form of a software product, the computer software product is stored in a storage medium, and includes a plurality of instructions enabling a computer device (which may be a personnel computer, a server, or a network device, etc.) to execute all or a part of the steps of the methods in embodiments of the present disclosure. The foregoing storage medium includes a variety of media capable of storing program codes, such as a USB disk, a mobile hard disk, a read-only memory (ROM), a random access memory (RAM), a magnetic disk, an optical disk or the like.

In the description of the present disclosure, it should be noted that the terms “center”, “upper”, “lower”, “left”, “right”, “vertical”, “horizontal”, “inner”, “outer”, etc., indicating the orientation or positional relationship, are based on the orientation or positional relationship shown in the drawings, and are only for the convenience of describing the present disclosure and simplifying the description, rather than indicating or implying that the device or element referred to must have a specific orientation, be constructed and operated in a specific orientation, and therefore cannot be understood as a limitation of the present disclosure. In addition, the terms “first”, “second”, and “third” are used for descriptive purposes only, and cannot be understood as indicating or implying relative importance.

Finally, it should be noted that the above-mentioned embodiments are only specific embodiments of the present disclosure, and are used to illustrate the technical solutions of the present disclosure, but not to limit them. The protection scope of the present disclosure is not limited thereto, although the present disclosure has been described in detail with reference to the foregoing embodiments, those ordinarily skilled in the art should understand that: any person skilled in the art who is familiar with the technical field can still make modifications or can easily think of changes to the technical solutions described in the foregoing embodiments within the technical scope disclosed by the present disclosure, or perform equivalent replacements to some of the technical features thereof; and these modifications, changes or substitutions do not make the essence of the corresponding technical solutions deviate from the spirit and scope of the technical solutions in the embodiments of the present disclosure. All should be included within the protection scope of the present disclosure. Therefore, the protection scope of the present disclosure shall be subject to the protection scope of the claims.

1. A method for managing a group chat message, comprising:
in response to a creation operation of a target topic, displaying topic content with a topic tag of the target topic in a group chat content display area, wherein a graphical user interface is provided by a terminal device, the graphical user interface comprises the group chat content display area, and the group chat content display area is configured to display content sent by a group member in a target group; and
in response to a viewing operation for the topic tag, displaying a topic management page of the target topic, wherein the topic management page is configured to display the topic content under the target topic.

2. The method according to claim 1, wherein, in response to the creation operation of the target topic, displaying the topic content with the topic tag of the target topic in the group chat content display area comprises:
providing a content input area through the graphical user interface, wherein the content input area comprises an input box and a topic creation control;
in response to the creation operation for the topic creation control, generating the topic tag of the target topic;
in response to an input operation for the input box, obtaining the topic content; and
in response to a confirmation operation for a sending control in the content input area, sending the topic content with the topic tag of the target topic to the group chat content display area for display.

3. The method according to claim 2, wherein, in response to the creation operation for the topic creation control, generating the topic tag of the target topic comprises:
in response to the creation operation for the topic creation control, generating the topic tag of the target topic in the input box.

4. The method according to claim 1, wherein, in response to the creation operation of the target topic, displaying the topic content with the topic tag of the target topic in the group chat content display area comprises:
in response to a selection operation for target content displayed in the group chat content display area, displaying an operation panel, wherein the operation panel comprises a topic creation control;
in response to a selection operation for the topic creation control, creating the topic tag of the target topic for the target content, and obtaining the topic content with the topic tag of the target topic; and
displaying the topic content with the topic tag of the target topic in the group chat content display area.

5. (canceled)

6. The method according to claim 1, wherein the topic management page further comprises a configuration control, and the method further comprises:
in response to a configuration operation for the configuration control, obtaining configuration information for the target topic; and
configuring the target topic according to the configuration information.

7. The method according to claim 6, wherein the configuration control comprises a message configuration control, and in response to the configuration operation for the configuration control, obtaining the configuration information for the target topic comprises:
in response to the configuration operation for the message configuration control, displaying the group chat content display area; and
in response to a selection operation for target content in the group chat content display area, using the target content as the configuration information;
configuring the target topic according to the configuration information comprises:
adding the target content to the topic management page of the target topic.

8. The method according to claim 7, wherein the method further comprises:
in response to the selection operation for the target content in the group chat content display area, adding the topic tag of the target topic to the target content in the group chat content display area.

9. The method according to claim 6, wherein the configuration control comprises a message configuration control, and in response to the configuration operation for the configuration control, obtaining the configuration information for the target topic comprises:
in response to the configuration operation for the message configuration control, controlling the topic content in the topic management page to enter a selectable state; and
in response to a selection operation for target topic content in the topic management page, using the target topic content as the configuration information;
configuring the target topic according to the configuration information comprises:
deleting the target topic content from the topic management page of the target topic.

10. The method according to claim 9, wherein the method further comprises:
in response to the selection operation for the target topic content in the topic management page, deleting a topic tag of the target topic content in the group chat content display area.

11. The method according to claim 6, wherein the configuration control comprises a reminder configuration control, and in response to the configuration operation for the configuration control, obtaining the configuration information for the target topic comprises:
in response to the configuration operation for the reminder configuration control, obtaining the configuration information for the target topic;
configuring the target topic according to the configuration information comprises:
displaying, according to the configuration information, a reminder message for the target topic in the group chat content display area.

12. The method according to claim 11, wherein the reminder configuration control comprises a first reminder configuration control, and in response to the configuration operation for the reminder configuration control, obtaining the configuration information for the target topic comprises:
in response to the configuration operation for the first reminder configuration control, determining a group member to be reminded for the target topic, wherein the configuration information comprises the group member to be reminded;
displaying, according to the configuration information, the reminder message for the target topic in the group chat content display area comprises:
sending the reminder message for the target topic to the group member to be reminded to cause the group chat content display area displayed on a terminal device of the group member to be reminded to display the reminder message.

13. The method according to claim 12, wherein the method further comprises:
in response to a click operation for the reminder message, displaying the topic management page of the target topic on the terminal device of the group member to be reminded; or
in response to the click operation for the reminder message, generating the topic tag of the target topic in an input box displayed on the terminal device of the group member to be reminded.

14. (canceled)

15. The method according to claim 11, wherein the reminder configuration control comprises a second reminder configuration control, and in response to the configuration operation for the reminder configuration control, obtaining the configuration information for the target topic comprises:
in response to the configuration operation for the second reminder configuration control, determining a discussion duration for the target topic, wherein the configuration information comprises the discussion duration;
displaying, according to the configuration information, the reminder message for the target topic in the group chat content display area comprises:
displaying, according to the discussion duration, the reminder message for a remaining discussion duration of the target topic in the group chat content display area.

16. The method according to claim 15, wherein the method further comprises:
in response to the remaining discussion duration being equal to zero, hiding the reminder message.

17. The method according to claim 6, wherein the configuration control comprises a group chat configuration control;
in response to the configuration operation for the configuration control, obtaining the configuration information for the target topic comprises:
in response to the configuration operation for the group chat configuration control, obtaining the configuration information of a discussion group for the target topic;
configuring the target topic according to the configuration information comprises:
creating the discussion group for the target topic according to the configuration information of the discussion group for the target topic; and
wherein the configuration information comprises at least one of: a name of the discussion group, or a designated group member of the discussion group.

18. (canceled)

19. The method according to claim 1, wherein the method further comprises:
providing a discussion viewing control through the graphical user interface; and
in response to a selection operation for the discussion viewing control, displaying at least part of topics related to the target group.

20. The method according to claim 19, wherein the at least part of topics comprises a topic under discussion; and
the method further comprises:
in response to a blocking operation for a designated topic among the displayed at least part of topics, cancelling display of the designated topic, and blocking topic content with a topic tag of the designated topic in the group chat content display area.

21. (canceled)

22. The method according to claim 1, wherein, in response to the viewing operation for the topic tag, displaying the topic management page of the target topic comprises:
in response to the viewing operation for the topic tag, displaying a preview page of the target topic in the group chat content display area, wherein the preview page is configured to display at least part of the topic content under the target topic and a message input box, and the message input box comprises the topic tag of the target topic; and
in response to an expansion operation for the preview page, displaying the topic management page of the target topic.

23. (canceled)

24. An electronic device, comprising a processor and a memory, wherein computer-executable instructions that are executable by the processor are stored in the memory, and the processor executes the computer-executable instructions to implement:
in response to a creation operation of a target topic, displaying topic content with a topic tag of the target topic in a group chat content display area, wherein a graphical user interface is provided by the electronic device, the graphical user interface comprises the group chat content display area, and the group chat content display area is configured to display content sent by a group member in a target group; and
in response to a viewing operation for the topic tag, displaying a topic management page of the target topic, wherein the topic management page is configured to display the topic content under the target topic.

25. A non-transitory computer readable storage medium having computer-executable instructions stored thereon, which, when invoked and executed by a processor, cause the processor to implement:
in response to a creation operation of a target topic, displaying topic content with a topic tag of the target topic in a group chat content display area, wherein a graphical user interface is provided by a terminal device, the graphical user interface comprises the group chat content display area, and the group chat content display area is configured to display content sent by a group member in a target group; and
in response to a viewing operation for the topic tag, displaying a topic management page of the target topic, wherein the topic management page is configured to display the topic content under the target topic.
